(19) United States
(12) Patent Application Publication
(10) Pub. No.: US 2011/0010773 A1
(43) Pub. Date: Jan. 13, 2011

(54) HARDWARE COMMAND FILTER MATRIX INTEGRATED CIRCUIT WITH RESTRICED COMMAND ENFORCEMENT CAPABILITY

(75) Inventors: Lon Daniel MCPHAIL, San Diego, CA (US); David S. Gillett, San Diego, CA (US)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: KUITY CORP., San Diego, CA (US)

(21) Appl. No.: 12/831,974

(22) Filed: Jul. 7, 2010

Related U.S. Application Data
(60) Provisional application No. 61/223,647, filed on Jul. 7, 2009.
(60) Provisional application No. 61/254,567, filed on Oct. 23, 2009.

(51) Int. Cl. G06F 11/00

(52) U.S. Cl. 726/23; 726/22

(57) ABSTRACT

A semiconductor integrated circuit includes a hardware mechanism arranged to ensure that associations between instructions and data are enforced so that a processor cannot execute an instruction that is not authorized. A Command Filter Matrix stores entries comprising instructions and associated data memory ranges. A hardware arrangement denies command execution if the CPU attempts to make a data fetch from an instruction that is outside the range associated with data in the Command Filter Matrix. The Command Filter Matrix may be implemented in a Field Programmable Gate Array such that the memory cell content is pre-programmed with entrusted code by a separate trusted hardware source. In this way, an operating system may function normally but only execute trusted instructions, commands and memory operations. The Command Filter Matrix also contains external write-only capability to enable external monitoring of performance.

### CROSS-REFERENCE TO RELATED APPLICATIONS

The present Application claims priority from U.S. Provisional Patent Application No. 61/223,647 that was filed Jul. 7, 2009 and from U.S. Provisional Patent Application No. 61/254,567 that was filed Oct. 23, 2009, which applications are expressly incorporated by reference herein for all purposes.

### BACKGROUND OF THE INVENTION

1. Field of the Invention

The present invention relates generally to integrated circuits and more particularly to controlling the code that can be executed on microprocessors using a combination of hardware and software command filters.

2. Description of Related Art

Related art is drawn from two fields: software that implements or controls data flow into or out of a microprocessor-driven system under security protocols or policies and hardware implemented as network firewall protection.

### BRIEF SUMMARY OF THE INVENTION

Certain embodiments of the present invention comprise systems and methods applicable to integrated circuits including microprocessors, including microprocessors used in personal computers, workstations, servers, networking devices, telecommunications devices, encryption hardware, mechanized vehicles of all types, and any device with the capability of storing, transporting, or processing of data and data control system applications. According to certain aspects of the invention, a processor may not run unauthorized and/or undesired code that could impair or compromise either the integrity of the data or function of the system.

### BRIEF DESCRIPTION OF THE DRAWINGS

FIG. 1 is a block diagram illustrating a command filter matrix according to certain aspects of the invention.

FIG. 2 depicts a signal transport filter mechanism according to certain aspects of the invention.

FIG. 3 is a simplified drawing depicting one example of an embodiment according to certain aspects of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

For the purposes of this description, a command filter matrix is understood to mean a proprietary hardware device that may be embodied in a memory cell matrix encoded and configured by a trusted source. For the purposes of this description, malicious hardware is understood to mean a functionality that is embedded in external (to the microprocessor) peripheral devices, integrated circuits or memory devices and considered potentially harmful. For the purposes of this description, hardware exploitation malware (“malware”) is understood to mean software components, such as computer viruses, which are designed to exploit unauthorized run-time capabilities of an electronic data processing environment.

Certain embodiments of the present invention comprise systems and methods applicable to integrated circuits including microprocessors, including microprocessors used in personal computers, workstations, servers, networking devices, telecommunications devices, encryption hardware, mechanized vehicles of all types, and any device with the capability of storing, transporting, or processing of data and data control system applications. According to certain aspects of the invention, a command filter matrix comprising a trusted-source filtering element that prevents a processor from running unauthorized and/or undesired code that could impair or compromise either the integrity of the data or function of the system.

Certain embodiments of the invention provide systems, methods, processes, circuits and tools to assure that only trusted commands and instructions are executed by a microprocessor. According to certain aspects of the invention, a universal solution may be employed to assure that malicious hardware content, present in unknown hardware and software system resources, is prevented from entering, controlling or compromising any system under control of the microprocessor or related integrated circuit.

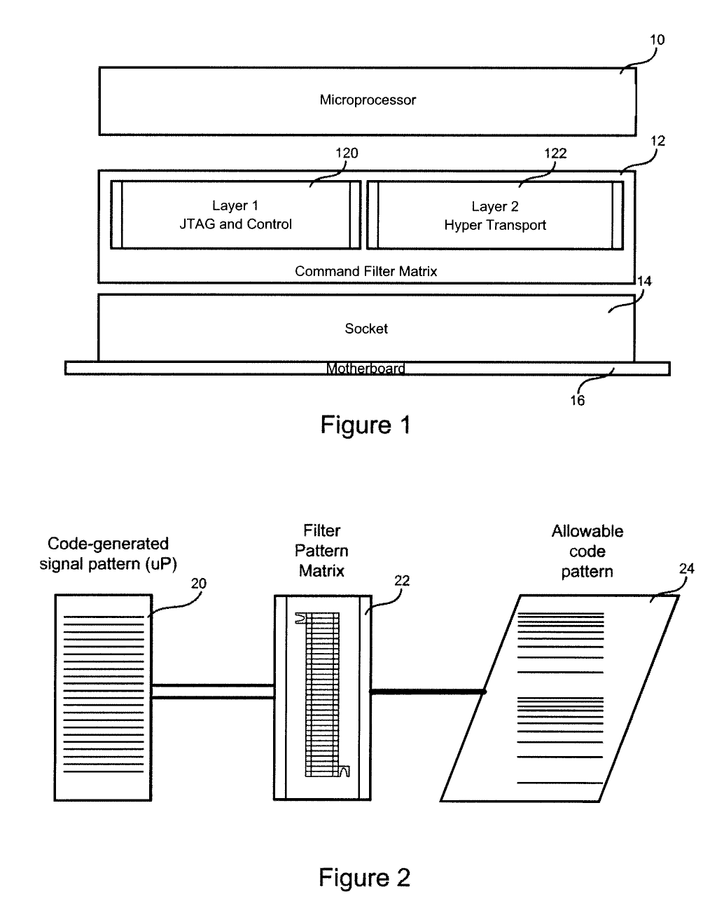

With reference to FIG. 1, certain embodiments provide a proprietary in-line hardware device 12 that creates a trusted-source filter for microprocessor 10 or integrated circuit code execution. Trusted source filter 12 may comprise layered control elements, including, for example, a layer 1 JTAG and control element 120 and a layer 2 hyper transport element 122. In one example, trusted source filter 12 is inserted between microprocessor 10 and a socket 14 provided on motherboard 16. In another example, a lightweight, lower profiled embodiment is achieved by embedding the command filter matrix within the Socket itself, thus eliminating elevation growth.

Referring also to FIG. 2, a two-layer detection and protection scheme can be implemented on an integrated circuit, which is designated herein as the command filter matrix chip (CFM) 12. The CFM 12 is typically embedded into a hardware construct wherein the signal input is a microprocessor and the signal output is engaged into the normal socket 14 or direct interconnect to motherboard 16 where the microprocessor 10 is normally inserted or connected, thus providing a physical standoff barrier to the normal interconnect. Signals originating from the microprocessor 10 are diverted into CFM 12 for parsing. The CFM 12 can comprise memory cells capable of being externally programmed from a trusted hardware source. According to certain aspects of the invention, the memory cells are programmed as a command filter matrix 12 that parses instructions, commands, data fetches and memory destination addresses originating from the microprocessor 10. Based on the image programmed by the trusted hardware source device, the CFM 12 will only allow trusted instructions, commands, data fetches and memory destination addresses to be transported as output signals. This transport filter mechanism is illustrated in FIG. 2.

CFM 12 can be implemented in two independent modules 120 and 122 that interdict microprocessor signals from different code execution partitions of the microprocessor 10. As illustrated, JTAG/Debug and Control module 120 and a HyperTransport Interface module 122 may be employed. The CFM 12 can be configured as a filter matrix to selectively restrict transportation of signals across the filter interface to patterns that match a limited pattern set 24. Accordingly, the filter interface can serve to aggressively defend the microprocessor 10 and its associated system from external malicious attack and control.

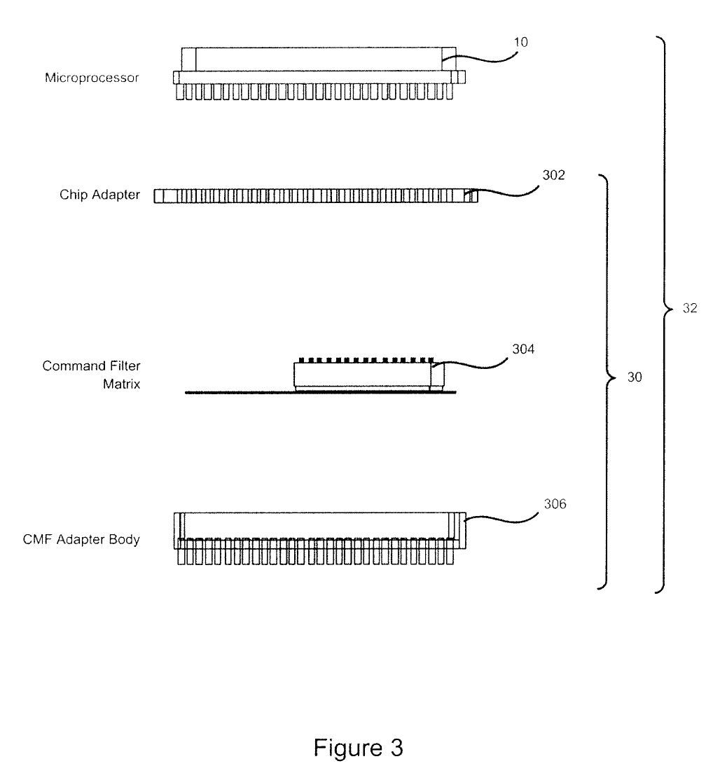

With reference to FIGS. 1 and 3, one example of a system according to certain aspects of the invention is embodied within a physical body constructed to house an assembly comprising a printed wire board (PWB) 16, one or more integrated circuits, such as microprocessor 10, and any necessary electrical interconnect to provide signal, voltage, and control functionality. the one or more integrated circuits can be affixed to the PWB 16 to provide support, signal, and voltage interconnect as well as physical and structural integrity. Integrated circuits may come in many different design formats which accomplish the prescribed or desired functions.

In the example depicted in FIG. 3, a microprocessor adapter assembly 30 is selected to support the target microprocessor 10. Adapter assembly 30 may comprise a chip adapter 302 that performs one or more functions including, for example, routing and mapping signals between microprocessor 10 and CFM 304 or CFM adapter body 306, interception of signals and/or spoofing, replacing or simulating intercepted signals or otherwise missing signals. Adapter assembly 30 can assure secure interconnect of required signals to the one or more integrated circuits. The assembly 30 may be sealed with, for example, a solid curing polymer or epoxy. In at least some embodiments, the microprocessor 10 maybe mounted to the adapter assembly 30 prior to sealing, thereby providing a secured microprocessor 32.

The integrated circuit can be connected to an external trusted source hardware device for configuring, adaptation, test and/or for programming purposes. Connection to a trusted source may be provided through proprietary or standard connections such as JTAG and, in some embodiments, connection may be made through microprocessor interface, typically using a coded sequence. Trusted source programming localizes the universal device 304 to a microprocessor-specific (CFM) device. The CFM 304 may contain external reporting functionality and capability. However, the reporting function cannot typically be accessed by externally addressable memory and the reporting capability is incorporated in the device by ASIC etch.

In certain embodiments, the CFM 304 denies access to any out-of-bounds hardware attempting to connect to unassigned pins, factory test and configuration pins and other non-specified functions on the microprocessor 10. CFM 12 is positioned between the microprocessor 10 and the socket 14 wherein the functional run-time authorized data paths are correctly aligned. The CFM 12 can have a secondary configuration wherein the CFM 12 is manufactured as part of socket 14, and mounted permanently onto the circuit board 16, where it receives the microprocessor 10.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide a secured semiconductor integrated circuit. Some of these embodiments comprise an interconnect configured to intercept signals transmitted between an integrated circuit device and a circuit board. Some of these embodiments comprise a command filter matrix configured to receive the intercepted signals and to selectively transmit the intercepted signals to the circuit board or the integrated circuit device. In some of these embodiments, the command filter matrix is configured by a trusted source. In some of these embodiments, the command filter maintains a set of associations between instructions and data according to characteristics of a target microprocessor device. In some of these embodiments, the command filter maintains a set of associations between instructions, data and characteristics of a target microprocessor device. In some of these embodiments, the command filter matrix transmits only intercepted signals that match entries in the set of associations maintained by the command filter matrix.

In some of these embodiments, the trusted source configures the command filter matrix using a secure process. In some of these embodiments, the command filter matrix hardware comprises a hardware memory matrix. In some of these embodiments, the hardware memory matrix is configured to operate as a code comparator. In some of these embodiments, the selective transmission of the intercepted signals is controlled by the code comparator. In some of these embodiments, the command filter matrix blocks transmission of intercepted signals that conform to a pattern indicative of malware. In some of these embodiments, the command filter matrix is configured to block malware from being executed by the microprocessor. In some of these embodiments, the command filter matrix and the interconnect are embodied in a socket adapted to receive the microprocessor. In some of these embodiments, the command filter matrix and the interconnect are embodied in a component configured for insertion between the microprocessor and a socket adapted to receive the microprocessor.

Certain embodiments of the invention provide a method for controlling semiconductor devices. In some of these embodiments, the method comprises providing a command filter matrix between a microprocessor and a circuit board. In some of these embodiments, the method comprises redirecting signals transmitted between the microprocessor and the circuit board to the command filter matrix. In some of these embodiments, the command filter matrix is configured to receive an address from the microprocessor. In some of these embodiments, the command filter matrix is configured to determine if the address is a valid program-instruction address. In some of these embodiments, the command filter matrix is configured to permit a program instruction to be fetched from the address if the address is a valid program-instruction address. In some of these embodiments, the command filter matrix is configured to redirect the microprocessor to a different address if the address is an invalid program-instruction address. In some of these embodiments, the validity of the program-instruction address is determined based on set of signal patterns maintained by the filter matrix. In some of these embodiments, the program instruction includes a request for data from a data address. In some of these embodiments, the command filter matrix is configured to determine whether the program instruction is one of a group of instructions permitted to request the data from the data address. In some of these embodiments, the command filter matrix is configured to permit the data to be retrieved from the data address when the program instruction is one of the group of instructions permitted to request the data from the data address. In some of these embodiments, the command filter matrix is configured to prevent the data from being retrieved from the data address when the program instruction is not included in the group of instructions permitted to request the data from the data address. In some of these embodiments, responsive to determining if the address is a valid program-instruction address, the command filter matrix is configured to redirect one or more input signals of the microprocessor to corresponding buffers selected based on the validity of the program-instruction address. In some of these embodiments, responsive to determining if the address is a valid program-instruction address, the command filter matrix is configured to redirect one or more output signals of the microprocessor to corresponding buffers selected based on the validity of the program-instruction address.

Certain embodiments of the invention provide devices including semiconductor devices. Some of these embodiments comprise an interconnect configured to intercept signals transmitted from a microprocessor provided in an integrated circuit device to a socket configured to receive the integrated circuit. Some of these embodiments comprise a command filter matrix configured to receive the intercepted signals and to selectively transmit certain of the intercepted signals to the socket. In some of these embodiments, the command filter matrix is configured using a secured configuration process. In some of these embodiments, the secured configuration provides a set of associations to the command filter matrix. In some of these embodiments, the set of associations identifies patterns of signals corresponding to instructions and data associated with the microprocessor. In some of these embodiments, the command filter matrix transmits only intercepted signals that match a pattern of signals identified by the set of associations in the command filter matrix. In some of these embodiments, the command filter matrix is configured by a trusted source. In some of these embodiments, the command filter matrix hardware comprises a code comparator. In some of these embodiments, the code comparator is configured to identify a plurality of valid program instructions from the pattern of signals. In some of these embodiments, the plurality of valid program instructions includes instructions permitted to request data from predetermined data addresses. In some of these embodiments, the plurality of valid program instructions includes instructions located at one or more addresses.

Certain embodiments of the invention provide a semiconductor integrated circuit. Some of these embodiments comprise a command filter matrix arranged so that it may only be programmed by a secure process and arranged to store associations between instructions and data according to requirements resulting from specification of a target microprocessor device. In some of these embodiments, the secure process is arranged to program the command filter matrix from a trusted source. In some of these embodiments, the hardware mechanism comprises a hardware memory matrix programmable as a code comparator. In some of these embodiments, the input and output of signals is controlled by the logical output of the code comparator. In some of these embodiments, hardware and embedded logic functions deny Hardware Exploitation Malware from entering the processing core.

Certain embodiments of the invention provide security process and methods used in semiconductor devices. Some of these embodiments provide an ability to fetch a program instruction from an actual address via a virtual address. Some of these embodiments comprise determining whether the actual address is a valid program-instruction address. Some of these embodiments comprise fetching the program instruction from the actual address if the actual address is a valid program-instruction address; and generating a go/no-go determination. In some of these embodiments, the program instruction includes a request for data from a data address. Some of these embodiments comprise determining whether the program instruction is within a group of instructions allowed to request the data. Some of these embodiments comprise retrieving the data from the data address if the program instruction is within the group of instructions; and generating a go/no-go determination. Some of these embodiments provide an ability to switch or shunt input and output signals to specific input and output buffers according to the logical output of the go/no-go determination.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A semiconductor integrated circuit comprising:
an interconnect configured to intercept signals transmitted between an integrated circuit device and a circuit board; and
a command filter matrix configured to receive the intercepted signals and to selectively transmit the intercepted signals to the circuit board or the integrated circuit device, wherein
the command filter matrix is configured by a trusted source and maintains a set of associations between instructions, data and characteristics of a target microprocessor device, wherein
the command filter matrix transmits only intercepted signals that match entries in the set of associations maintained by the command filter matrix.

2. A semiconductor integrated circuit according to claim 1, wherein the trusted source configures the command filter matrix using a secure process.

3. A semiconductor integrated circuit according to claim 1, wherein the command filter matrix hardware comprises a hardware memory matrix.

4. A semiconductor integrated circuit according to claim 3, wherein the hardware memory matrix is configured to operate as a code comparator.

5. A semiconductor integrated circuit according to claim 4, wherein the selective transmission of the intercepted signals is controlled by the code comparator.

6. A semiconductor integrated circuit according to claim 1, wherein the command filter matrix blocks transmission of intercepted signals that conform to a pattern indicative of malware.

7. A semiconductor integrated circuit according to claim 6, wherein the command filter matrix is configured to block malware from being executed by the microprocessor.

8. A semiconductor integrated circuit according to claim 1, wherein the command filter matrix and the interconnect are embodied in a socket adapted to receive the microprocessor.

9. A semiconductor integrated circuit according to claim 1, wherein the command filter matrix and the interconnect are embodied in a component configured for insertion between the microprocessor and a socket adapted to receive the microprocessor.

10. A method, comprising:
providing a command filter matrix between a microprocessor and a circuit board;
redirecting signals transmitted between the microprocessor and the circuit board to the command filter matrix, wherein the command filter matrix is configured to
receive an address from the microprocessor,
determine if the address is a valid program-instruction address,
permit a program instruction to be fetched from the address if the address is a valid program-instruction address, and
redirect the microprocessor to a different address if the address is an invalid program-instruction address,
wherein the validity of the program-instruction address is determined based on set of signal patterns maintained by the filter matrix.

11. The method of claim 10, wherein the program instruction includes a request for data from a data address.

12. The method of claim 11, wherein the command filter matrix is configured to:
determine whether the program instruction is one of a group of instructions permitted to request the data from the data address;
permit the data to be retrieved from the data address when the program instruction is one of the group of instructions permitted to request the data from the data address; and
prevent the data from being retrieved from the data address when the program instruction is not included in the group of instructions permitted to request the data from the data address.

13. The method of claim 10, wherein responsive to determining if the address is a valid program-instruction address, the command filter matrix is configured to redirect one or more input signals of the microprocessor to corresponding buffers selected based on the validity of the program-instruction address.

14. The method of claim 10, wherein responsive to determining if the address is a valid program-instruction address, the command filter matrix is configured to redirect one or more output signals of the microprocessor to corresponding buffers selected based on the validity of the program-instruction address.

15. A device comprising:
an interconnect configured to intercept signals transmitted from a microprocessor provided in an integrated circuit device to a socket configured to receive the integrated circuit; and
a command filter matrix configured to receive the intercepted signals and to selectively transmit certain of the intercepted signals to the socket, wherein
the command filter matrix is configured using a secured configuration process that provides a set of associations to the command filter matrix, the set of associations identifying patterns of signals corresponding to instructions and data associated with the microprocessor, wherein
the command filter matrix transmits only intercepted signals that match a pattern of signals identified by the set of associations in the command filter matrix.

16. The device of claim 15, wherein the command filter matrix is configured by a trusted source.

17. The device of claim 15, wherein the command filter matrix hardware comprises a code comparator configured to identify a plurality of valid program instructions from the pattern of signals.

18. The device of claim 17, wherein the plurality of valid program instructions includes instructions permitted to request data from predetermined data addresses.

19. The device of claim 17, wherein the plurality of valid program instructions includes instructions located at one or more addresses.
